(19) United States
(12) Patent Application Publication
(10) Pub. No.: US 2013/0073430 A1
(43) Pub. Date: Mar. 21, 2013

(54) GIFT GIVING SYSTEM AND METHOD

(71) Applicants: Russell Ivan Gallen, Phoenix, AZ (US); Joseph Daniel Lindquist, Scottsdale, AZ (US); Daniel Ian Redman, San Diego, CA (US)

(72) Inventors: Russell Ivan Gallen, Phoenix, AZ (US); Joseph Daniel Lindquist, Scottsdale, AZ (US); Daniel Ian Redman, San Diego, CA (US)

(73) Assignee: OPTIMUM ENTERPRISES, LLC, Scottsdale, AZ (US)

(21) Appl. No.: 13/612,643

(22) Filed: Sep. 12, 2012

Related U.S. Application Data
(60) Provisional application No. 61/535,275, filed on Sep. 15, 2011.

(51) Int. Cl. G06Q 30/06

(52) U.S. Cl. 705/26.41

(57) ABSTRACT

Systems, methods, and computer program products capable of facilitating gift giving are disclosed. The social media contacts of a consumer may be identified. Personal information may be stored for the social media contacts. The consumer may enter gift criteria for the social media contacts, and based on the criteria, it may be determined that a social media contact should receive a gift for a particular occasion. A gift may be automatically purchased and sent to the social media contact on behalf of the consumer.

### CROSS-REFERENCE TO RELATED APPLICATIONS

This application claims priority to U.S. Provisional Application Ser. No. 61/535,275 entitled “Gift Giving System and Method” and filed on Sep. 15, 2011, which is incorporated herein by reference in its entirety.

### FIELD

The present disclosure relates generally to gift giving, and more particularly to gift giving via computer-based systems.

### BACKGROUND

Giving a gift to someone can be a burdensome task. For example, a person typically needs a system for remembering the correct date. Dates for birthdays, anniversaries, graduations, holidays, etc. are often either mentally remembered or written down in a calendar. If the dates are forgotten or lost, it may be time consuming to reacquire the dates.

A proper gift must also be selected. Out of the millions of items available in stores and on the internet, only one or a few must be selected to give to the recipient. However, it can be difficult to know which gifts are the new, popular gifts, as well as which items the recipient already owns.

The gift typically needs to be delivered to the recipient. Delivery may require obtaining and maintaining addresses of many individuals who are often moving and changing addresses, and manually entering such information into a website.

Therefore, a system and method which facilitates the giving of gifts is needed.

### SUMMARY

Systems, methods, and computer program products capable of facilitating gift giving are disclosed. In various embodiments, methods may include identifying, by a computer-based system, social media contacts of a consumer. Methods may include acquiring personal information for the social media contacts. Based on consumer preferences, it may be determined that the social media contacts should receive a gift. A gift may be sent to the social media contacts on behalf of the consumer.

In various embodiments, the computer-based system may select a gift based on the popularity of various gifts being purchased. The gift may be automatically purchased on behalf of the consumer and sent to a social media contact.

### BRIEF DESCRIPTION OF THE DRAWINGS

FIG. 1 illustrates a system for facilitating gift giving according to various embodiments.

FIG. 2 illustrates a process for facilitating gift giving according to various embodiments.

### DETAILED DESCRIPTION

The detailed description of exemplary embodiments herein makes reference to the accompanying drawings and pictures, which show various embodiments by way of illustration. While these various embodiments are described in sufficient detail to enable those skilled in the art to practice the disclosure, it should be understood that other embodiments may be realized and that logical and mechanical changes may be made without departing from the spirit and scope of the disclosure. Thus, the detailed description herein is presented for purposes of illustration only and not of limitation. For example, the steps recited in any of the method or process descriptions may be executed in any order and are not limited to the order presented. Moreover, any of the functions or steps may be outsourced to or performed by one or more third parties. Furthermore, any reference to singular includes plural embodiments, and any reference to more than one component may include a singular embodiment.

Systems, methods and computer program products are provided. In the detailed description herein, references to “various embodiments”, “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

Systems, methods, and articles of manufacture are provided which facilitate gift giving. In various embodiments, a consumer may access a Gift Giving System (“GGS”). The access to GGS may be via a social media site, such as Facebook®, LinkedIn®, MySpace®, or Twitter®. Consumers may also access GGS via a website, an application on a mobile device and/or other systems. A consumer may grant GGS access to information about the consumer's contacts via the social media sites. For example, GGS may crawl the social media accounts of the consumer's contacts and gather information such as name, birthday, anniversary, address, etc. Additionally, GGS may access the contacts in the consumer's email accounts, and the consumer may cause information to be entered into GGS for additional contacts (e.g., manually entered).

GGS may crawl the various social media sites for available information for each of the consumer's contacts. For example, GGS may collect data from each of the consumer's contacts in Facebook® profiles to gather information such as name, birthday, age, sex, email address, location, and mailing address. Additionally, GGS may collect data regarding the likes and interests of the contacts, or any other information available. For example, GGS may determine that a contact has listed a particular rock band on their profile, and GGS may use that information in selecting a gift for that contact.

Those skilled in the art will recognize that there are many additional data sources which may be compatible with the present disclosure. GGS may gather data from internal databases, including merchant databases, as well as third party data sources such as credit reporting agencies, public records, purchased customer lists, etc. In various embodiments, GGS may use such data in combination with, or instead of, data gathered from social media sites in order to facilitate gift-giving.

In various embodiments, GGS may maintain a database comprising all or part of the information regarding the consumer's contacts. The system may also obtain information in real-time, batch, periodic and/or the like. The consumer may have the option to select various occasions or dates for which the contacts are to receive a gift. For example, the consumer may select the occasions “Christmas” and “Birthday” for a contact to receive a gift. These selections may be customized to each contact or groups of contacts, or may be applied to the entire contact list. GGS may use the information to compile a list of occasions for which a gift should be sent. GGS may provide the list to the consumer. The list may be added to a calendar, such that the consumer may view upcoming gift occasions for a contact or for all contacts. In various embodiments, a reminder may be sent to the consumer regarding an upcoming gift occasion. In addition, GGS may identify triggers on social media sites that indicate a gift should be sent. For example, GGS may identify a status update indicating that a contact has changed jobs or is getting married, and GGS may notify the consumer that a gift may be necessary.

In various embodiments, the consumer may add additional restrictions or preferences for the various contacts. The consumer may select spending limits or ranges for a particular contact and/or occasion. The consumer may select gift categories for particular contacts. For example, the consumer may select that a contact should receive a gift in a “sports equipment” or “apparel” category. The selections may be exclusive, such that the contact will only receive gifts in the selected categories. However, in various embodiments, the selection may be preferred, such that GGS may select a gift from the selected categories, but may alternatively select a gift from a different category if a better gift match is found. Additionally, the consumer may exclude gift categories. For example, categories may be selected such that a contact will never receive a gift in a “jewelry” or “electronics” category. If no categories are selected for a contact, GGS may determine that gifts in all categories may be selected for the contact. GGS may create a dashboard which allows the consumer to store and view past activities within GGS, as well as upcoming occasions and trending items.

GGS may take into account the various preferences for a contact, and search for gifts that match the selected preferences. GGS may identify popular or trending gifts via search engines, gift registries, and application program interfaces (“API”) for third party websites, such as Amazon®. GGS may provide suggested gifts to the consumer based on the preferences and popularity of gifts currently being purchased. In various embodiments, GGS may use an algorithm to rank the gifts and provide the top ranked gifts for the consumer to choose from. GGS may search a plurality of e-commerce sites in order to find the best price, least expensive delivery, quickest delivery, best options and/or the like for a particular gift. In various embodiments, the gifts may include downloadable content, such as MP3's, eBooks, Apps, gift cards, experiences and subscriptions.

In various embodiments, a gift may comprise a downloadable script capable of rendering a three-dimensional object. The recipient may download the script and use the script in connection with a three-dimensional printer. The script may comprise instructions which allow the three-dimensional printer to construct an object selected by the consumer or GGS. In various embodiments, the downloadable script may comprise a one-time use script such that, in response to the three-dimensional printer constructing the gift, the script may no longer be useable (or only partially usable). However, in various embodiments, the recipient may use the script to print as many gifts as the recipient desires, or for a limited time period.

In various embodiments, the rankings may be adjusted based on sponsorship from third parties. For example, a particular brand may sponsor GGS such that items from that brand are moved up a certain amount of spots in the rankings. In various embodiments, an algorithm may take into account sponsorship in order to improve the score of the item. Additionally, sponsorship may highlight or otherwise identify certain items in order to make them more appealing or noticeable to the consumer (e.g., pop-up window, blinking, etc). Additionally, third parties may provide discounts or other incentives to the consumer. For example, the consumer may be presented with a list of suggested gifts, and a gift in the list may be associated with an offer (e.g., points, discount or rebate) if the consumer buys a particular gift, uses a specific credit card to purchase the specified gift, buys the gift within a certain date range, etc.

In various embodiments, the consumer may select a gift, and GGS may purchase the gift on behalf of the consumer. GGS may request transaction account information from the consumer for each gift, a subset of gifts, particular recipients, etc. GGS may have previously stored transaction account information for a consumer, and GGS may use the stored transaction account information to purchase a gift for all or a subset of recipients. For example, the consumer may authorize GGS to use a pre-submitted transaction account for certain recipients (or certain occasions, dates, etc), a second transaction account for other recipients (or certain occasions, dates, etc) and set the GGS to request a transaction account for certain recipients (or certain occasions, dates, etc).

In various embodiments, GGS may automatically ship gifts for selected occasions. A consumer may select to automatically ship gifts for any or all contacts, as well as for any or all occasions. The consumer may give pre-authorization for GGS to charge the consumer's transaction account and purchase a gift for a contact for any occasion. GGS may determine a preferred gift for a contact and automatically ship the gift prior to the date of the occasion in Order to ensure the gift arrives on time. GGS may charge the purchase to the consumer's stored. transaction account. In various embodiments, GGS may send a message to the consumer notifying the consumer that a gift is about to be auto-shipped. The consumer may have the option to cancel or change the gift order.

If GGS has address information for the gift recipient (e.g., from a social media account of the recipient or previously entered by the consumer), GGS may have the gift shipped to the recipient. In the event that GGS does not have address information for the recipient, GGS may obtain the address from the consumer or from the recipient. In various embodiments, GGS may transmit a message to the recipient. The message may be transmitted via email, social media message, text message, or any other communication means. The message may notify the recipient that GGS has a gift for the recipient, and request the recipient to enter address information.

In various embodiments, GGS may obtain a commission for the gift from a merchant or manufacturer. For example, GGS may be connected to the Amazon® Affiliate Program. GGS may alter the rankings of suggested items or automatically select an item based on the commission that GGS will receive from the merchant.

Consumers may earn loyalty points for using the various GGS services. In various embodiments, the consumer may earn loyalty points for each purchase made using GGS. Additionally, the consumer may earn loyalty points for each gift received through GGS. Thus, users may be encouraged to request that others purchase gifts for them through GGS. Additionally, users may earn loyalty points based on the amount or quality of feedback received, as well as for friends referred and for Tweets® and Facebook® posts.

In various embodiments, GGS may determine items that would have been shipped had the consumer been using auto-ship on previous occasions. GGS may use stored information regarding preferences for the consumer and the recipient, as well as information regarding the popularity of various items as of the date of the previous occasions. For example, a consumer may be using GGS to select a gift for a contact's birthday. GGS may provide the consumer with the option to view which item would have been auto-shipped to the contact on the contact's previous birthday had the consumer been using auto-ship. GGS may then provide the consumer with the option or suggestion to enroll in auto-ship.

In various embodiments, GGS may track the gifts that have been sent to a particular recipient. GGS may prevent the same gift from being sent to the same recipient by multiple consumers. For example, GGS may identify a list of popular items for a recipient in a particular age range and location. However, GGS may gray out or otherwise visually indicate that certain items have already been sent to the recipient. In various embodiments, GGS may remove the already purchased items from the list. In various embodiments, a recipient with a GGS account may additionally enter items that they already own or do not wish to receive, and GGS may remove such items from lists when other consumers are selecting a gift for the recipient.

GGS may save gift searches performed on behalf of a consumer. The consumer may be able to access previous searches performed for a contact using specific criteria without re-entering (or with minimal re-entry of) the criteria. Additionally, GGS may allow the consumer to refresh the search, and GGS may take into account currently popular and trending gift items within the previously provided gift criteria.

In various embodiments, GGS may connect to registries on third party websites. For example, GGS may determine from a contact's social media profile or update that the contact is registered with Macy's® for a wedding. If a consumer's preferences indicate that the contact should receive a wedding gift, GGS may access the registry via an API and purchase a gift on behalf of the consumer, or provide the consumer with a list of suggested gifts from the registry list.

In addition to sending gift items, GGS may allow consumers to send messages to their contacts. In various embodiments, the consumer may select that a message rather than a gift is to be sent for various occasions. On the date of the occasion, GGS may automatically send a message to a recipient. For example, GGS may determine that it is a contact's birthday, and GGS may transmit a birthday message to the contact on behalf of the consumer. The message may be sent via any communication means, such as a Facebook® message, or an email. The message may appear to originate from the consumer rather than from GGS, such that the recipient cannot tell that the consumer used an automated service to send the message. In various embodiments, GGS may store a plurality of different messages for an occasion and select (e.g., based on applicability or randomly) the particular message, such that the recipient cannot tell that the message is in an automated format.

In various embodiments, after a gift is sent, the recipient may be given the opportunity to send feedback to GGS or the consumer. The recipient may fill out a survey or otherwise rate the gift they have received. GGS may track the responses to gifts and alter future gift selection based on the responses. For example, if a recipient indicates that a particular gift was unsatisfactory, GGS may not recommend similar gifts for that recipient. Additionally, GGS may not recommend similar gifts for other contacts of the consumer.

GGS may store any data regarding the gifting of consumers and contacts. For example, GGS may store user preferences, past gifts, and feedback given by recipients. In various embodiments, GGS may sell such data to third parties for advertising purposes. Additionally, GGS may store cookies on the devices of consumers or on third party servers which allow advertising servers to target specific consumers or consumer groups.

GGS may also be employed in corporate gifting situations, GGS may obtain a list of business contacts for a consumer based on Outlook® contacts or a LinkedIn® profile. Based on the consumer preferences, GGS may automatically send holiday cards or gifts for other occasions to the various business contacts. Many businesses and employees are subject to strict standards regarding gifts given in the corporate setting. Thus, in various embodiments, when a gift is scheduled to be sent, GGS may notify a compliance officer or similar entity, and the gift may not be sent unless the compliance officer approves the gift.

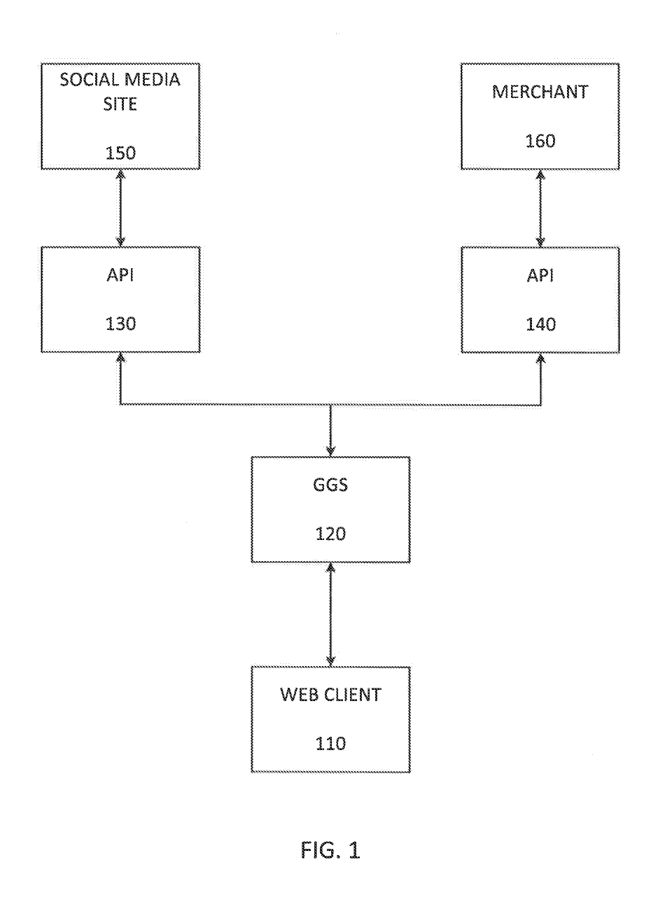

Referring to FIG. 1, a system for facilitating gift giving is illustrated according to various embodiments. The system may include web client 110, GGS 120, APIs 130, 140, social media site 150, and merchant 160. The various system components discussed herein may include one or more of the following: a host server or other computing systems including a processor for processing digital data; a memory coupled to the processor for storing digital data; an input digitizer coupled to the processor for inputting digital data; an application program stored in the memory and accessible by the processor for directing processing of digital data by the processor; a display device coupled to the processor and memory for displaying information derived from digital data processed by the processor; and a plurality of databases. Various databases used herein may include: client data; merchant data; financial institution data; and/or like data useful in the operation of the system. As those skilled in the art will appreciate, user computer may include an operating system (e.g., Windows NT, Windows 95/98/2000, Windows XP, Windows Vista, Windows 7, OS2, UNIX, Linux, Solaris, MacOS, etc.) as well as various conventional support software and drivers typically associated with computers.

Web client 110 may include any device (e.g., personal computer) which communicates via any network, for example such as those discussed herein. Such browser applications comprise Internet browsing software installed within a computing unit or a system to conduct online transactions and/or communications. These computing units or systems may take the form of a computer or set of computers, although other types of computing units or systems may be used, including laptops, notebooks, tablets, hand held computers, personal digital assistants, set-top boxes, workstations, computer servers, main frame computers, mini-computers, PC servers, pervasive computers, network sets of computers, personal computers, such as iPads, iMACs, and MacBooks, kiosks, terminals, point of sale (POS) devices and/or terminals, televisions, or any other device capable of receiving data over a network. A web-client may run Microsoft Internet Explorer, Mozilla Firefox, Google Chrome, Apple Safari, or any other of the myriad software packages available for browsing the internet.

Practitioners will appreciate that a web client may or may not be in direct contact with an application server. For example, a web client may access the services of an application server through another server and/or hardware component, which may have a direct or indirect connection to an Internet server. For example, a web client may communicate with an application server via a load balancer. In an exemplary embodiment, access is through a network or the Internet through a commercially-available web-browser software package.

As those skilled in the art will appreciate, a web client includes an operating system (e.g., Windows NT, 95/98/2000/CE/Mobile, OS2, UNIX, Linux, Solaris, MacOS, PalmOS, etc.) as well as various conventional support software and drivers typically associated with computers. A web client may include any suitable personal computer, network computer, workstation, personal digital assistant, cellular phone, smart phone, minicomputer, mainframe or the like. A web client can be in a home or business environment with access to a network. In an exemplary embodiment, access is through a network or the Internet through a commercially available web-browser software package. A web client may implement security protocols such as Secure Sockets Layer (SSL) and Transport Layer Security (TLS). A web client may implement several application layer protocols including http, https, ftp, and sftp.

Web client 110 may be in communication with GGS 120, GGS 120 may comprise any combination of hardware, software, and/or cloud computing capable of facilitating gift giving. In various embodiments, GGS 120 may be manifested as a web site or an application. GGS 120 may store information regarding consumer preferences and information regarding a consumer's contacts. GGS 120 may comprise and/or may be in communication with a plurality of API 130, 140.

API 130, 140 may comprise an interface implemented by a software program which enables the API to interact with other software. API 130, 140 may include a programming language that enables communication between computer programs, such as programs of GGS 120 and programs of a social media site 150 and/or third party merchants 160. API 130, 140 may be implemented by applications, libraries, and operating systems to determine vocabularies and calling conventions, and may be used to access services associated therewith. API 130, 140 may include specifications for routines, data structures, object classes, and protocols for communication. API 130, 140 may describe the ways in which a particular task is performed. API 130, 140 may define a set of request messages, along with a definition of the structure of response messages. API 130, 140 may be a backward compatible API. In some cases API 130, 140 may replace the need for and/or supplement middleware.

API 130, 140 may be used by more than one high-level programming language. Thus, API 130, 140 may facilitate automatically mapping to features (syntactic or semantic). This may be known as language binding, and is itself may be an API. Data fed to API 130, 140 may be automatically captured during the processing of a transaction, entered, and/or provided by a database (e.g., a merchant database, financial institution database and/or third-party database.)

API 130 may be in communication with social media site 150. Social media site 150 may comprise any combination of hardware, software, and/or cloud computing that allows a plurality of entities to interact. For example, social media site 150 may comprise one or more common sites such as Facebook®, LinkedIn®, Twitter®, and MySpace®.

API 140 may be in communication with merchant 160. Merchant 160 may include any electronic commerce application capable of facilitating the sale of goods or services. For example, merchant 160 may comprise one or more common e-commerce sites such as Amazon® or Overstock®.

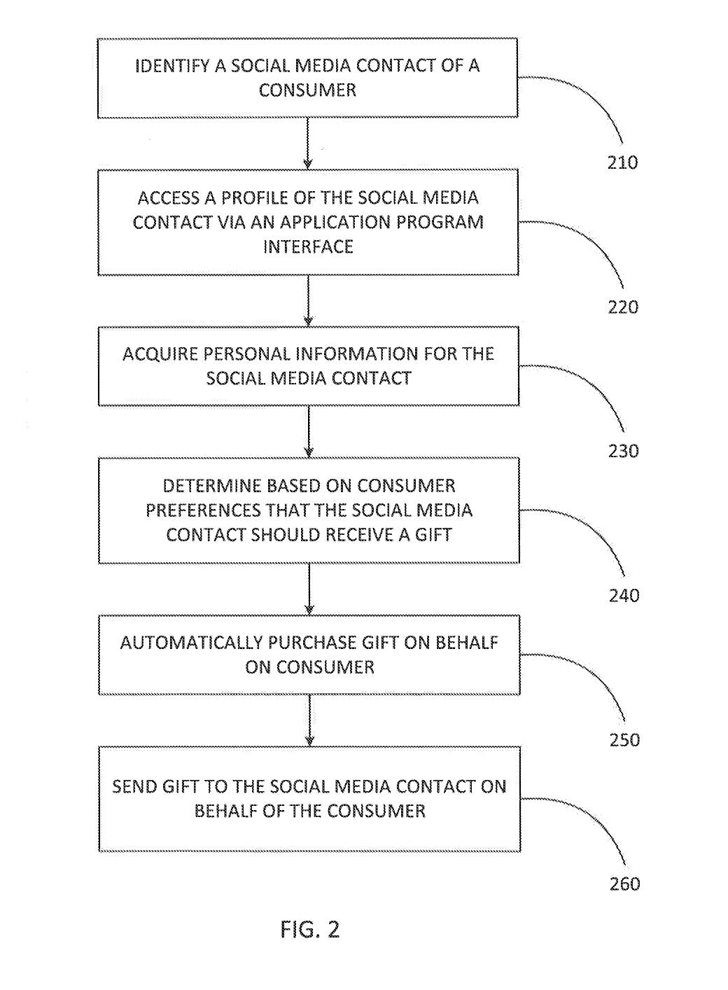

Referring to FIG. 2, a process for facilitating gift giving is illustrated according to various embodiments. The process may comprise identifying a social media contact of a consumer. (210). A consumer may grant GGS 120 authority to crawl social media sites 150 to compile a list of the consumer's contacts. Additionally, GGS 120 may obtain contacts by searching the consumer's email contacts or by the consumer manually entering contact information.

GGS 120 may access a profile of a social media contact via an API. (220). GGS 120 may scape personal information such as demographic information and likes or dislikes from the profile. (230). The consumer may provide GGS 120 with preferences regarding on what occasions the contact should receive a gift, as well as what type and how expensive of a gift. GGS may determine based on the preferences that the social media contact should receive a gift. (240).

Based on the preferences, GGS 120 may automatically purchase a gift for the contact on behalf of the consumer. (250). The consumer may have previously entered transaction account information into GGS 120, and GGS 120 may use the transaction account information to complete the purchase. However, in various embodiments, GGS 120 may provide the consumer with a plurality of gift options which the consumer may choose from. Additionally, the gift may be a free gift, such as a message. GGS 120 may send the gift to the social media contact on behalf of the consumer. (260).

The system and method is described herein with reference to screen shots, block diagrams and flowchart illustrations of methods, apparatus (e.g., systems), and computer program products according to various embodiments. It will be understood that each functional block of the block diagrams and the flowchart illustrations, and combinations of functional blocks in the block diagrams and flowchart illustrations, respectively, can be implemented by computer program instructions.

The process flows and screenshots depicted herein are merely embodiments and are not intended to limit the scope of the disclosure. For example, the steps recited in any of the method or process descriptions may be executed in any order and are not limited to the order presented. It will be appreciated that the description makes appropriate references not only to the steps and user interface elements depicted in the figures, but also to the various system components as described above with reference to FIG. 1.

In various embodiments, components, modules, and/or engines of the various systems may be implemented as micro-applications or micro-apps. Micro-apps are typically deployed in the context of a mobile operating system, including for example, a Palm mobile operating system, a Windows mobile operating system, an Android Operating System, Apple iOS, a Blackberry operating system and the like. The micro-app may be configured to leverage the resources of the larger operating system and associated hardware via a set of predetermined rules which govern the operations of various operating systems and hardware resources. For example, where a micro-app desires to communicate with a device or network other than the mobile device or mobile operating system, the micro-app may leverage the communication protocol of the operating system and associated device hardware under the predetermined rules of the mobile operating system. Moreover, where the micro-app desires an input from a user, the micro-app may be configured to request a response from the operating system which monitors various hardware components and then communicates a detected input from the hardware to the micro-app.

As used herein, the term “network” includes any cloud, cloud computing system or electronic communications system or method which incorporates hardware and/or software components. Communication among the parties may be accomplished through any suitable communication channels, such as, for example, a telephone network, an extranet, an intranet, Internet, point of interaction device (point of sale device, personal digital assistant (e.g., iPhone®, Palm Pilot®, Blackberry®), cellular phone, kiosk, etc.), online communications, satellite communications, off-line communications, wireless communications, transponder communications, local area network (LAN), wide area network (WAN), virtual private network (VPN), networked or linked devices, keyboard, mouse and/or any suitable communication or data input modality. Moreover, although the system is frequently described herein as being implemented with TCP/IP communications protocols, the system may also be implemented using IPX, Appletalk, IP-6, NetBIOS, OSI, any tunneling protocol (e.g. IPsec, SSH), or any number of existing or future protocols. If the network is in the nature of a public network, such as the Internet, it may be advantageous to presume the network to be insecure and open to eavesdroppers. Specific information related to the protocols, standards, and application software utilized in connection with the Internet is generally known to those skilled in the art and, as such, need not be detailed herein. See, for example, DILIP NAIK, INTERNET STANDARDS AND PROTOCOLS (1998); JAVA 2 COMPLETE, various authors, (Sybex 1999); DEBORAH RAY AND ERIC RAY, MASTERING HTML 4.0 (1997); and LOSHIN, TCP/IP CLEARLY EXPLAINED (1997) and DAVID GOURLEY AND BRIAN TOTTY, HTTP, THE DEFINITIVE GUIDE (2002), the contents of which are hereby incorporated by reference.

The various system components may be independently, separately or collectively suitably coupled to the network via data links which includes, for example, a connection to an Internet Service Provider (ISP) over the local loop as is typically used in connection with standard modern communication, cable modern, Dish networks, ISDN, Digital Subscriber Line (DSL), or various wireless communication methods, see, e.g., GILBERT HELD, UNDERSTANDING DATA COMMUNICATIONS (1996), which is hereby incorporated by reference. It is noted that the network may be implemented as other types of networks, such as an interactive television (ITV) network. Moreover, the system contemplates the use, sale or distribution of any goods, services or information over any network having similar functionality described herein.

“Cloud” or “Cloud computing” includes a model for enabling convenient, on-demand network access to a shared pool of configurable computing resources (e.g., networks, servers, storage, applications, and services) that can be rapidly provisioned and released with minimal management effort or service provider interaction. Cloud computing may include location-independent computing, whereby shared servers provide resources, software, and data to computers and other devices on demand. For more information regarding cloud computing, see the NIST's (National Institute of Standards and Technology) definition of cloud computing at http://csrc.nist.gov/publications/nistpubs/800-145/SP800-145.pdf (last visited June 2012), which is hereby incorporated by reference in its entirety.

As used herein, “transmit” may include sending electronic data from one system component to another over a network connection. Additionally, as used herein, “data” may include encompassing information such as commands, queries, files, data for storage, and the like in digital or any other form.

Phrases and terms similar to a “gift” or an “item” may include any good, service, information, experience, data, content, access, rental, lease, contribution, account, credit, debit, benefit, right, reward, points, coupons, credits, monetary equivalent, anything of value, something of minimal or no value, monetary value, non-monetary value and/or the like.

The system contemplates uses in association with web services, utility computing, pervasive and individualized computing, security and identity solutions, autonomic computing, cloud computing, commodity computing, mobility and wireless solutions, open source, biometrics, grid computing and/or mesh computing.

Any databases discussed herein may include relational, hierarchical, graphical, or object-oriented structure and/or any other database configurations. Common database products that may be used to implement the databases include DB2 by IBM (Armonk, N.Y.), various database products available from Oracle Corporation (Redwood Shores, Calif.), Microsoft Access or Microsoft SQL Server by Microsoft Corporation (Redmond, Wash.), MySQL by MySQL AB (Uppsala, Sweden), or any other suitable database product. Moreover, the databases may be organized in any suitable manner, for example, as data tables or lookup tables. Each record may be a single file, a series of files, a linked series of data fields or any other data structure. Association of certain data may be accomplished through any desired data association technique such as those known or practiced in the art. For example, the association may be accomplished either manually or automatically. Automatic association techniques may include, for example, a database search, a database merge, GREP, AGREP, SQL, using a key field in the tables to speed searches, sequential searches through all the tables and files, sorting records in the file according to a known order to simplify lookup, and/or the like. The association step may be accomplished by a database merge function, for example, using a “key field” in pre-selected databases or data sectors. Various database tuning steps are contemplated to optimize database performance. For example, frequently used files such as indexes may be placed on separate file systems to reduce In/Out (“I/O”) bottlenecks.

More particularly, a “key field” partitions the database according to the high-level class of objects defined by the key field. For example, certain types of data may be designated as a key field in a plurality of related data tables and the data tables may then be linked on the basis of the type of data in the key field. The data corresponding to the key field in each of the linked data tables is preferably the same or of the same type. However, data tables having similar, though not identical, data in the key fields may also be linked by using AGREP, for example. In accordance with one embodiment, any suitable data storage technique may be utilized to store data without a standard format. Data sets may be stored using any suitable technique, including, for example, storing individual files using an ISO/EEC 7816-4 file structure; implementing a domain whereby a dedicated file is selected that exposes one or more elementary files containing one or more data sets; using data sets stored in individual files using a hierarchical filing system; data sets stored as records in a single file (including compression, SQL accessible, hashed via one or more keys, numeric, alphabetical by first tuple, etc.); Binary Large Object (BLOB); stored as ungrouped data elements encoded using ISO/IEC 7816-6 data elements; stored as ungrouped data elements encoded using ISO/IEC Abstract Syntax Notation (ASN.1) as in ISO/IEC 882.4 and 8825; and/or other proprietary techniques that may include fractal compression methods, image compression methods, etc.

In various embodiments, the ability to store a wide variety of information in different formats is facilitated by storing the information as a BLOB. Thus, any binary information can be stored in a storage space associated with a data set. As discussed above, the binary information may be stored on the financial transaction instrument or external to but affiliated with the financial transaction instrument. The BLOB method may store data sets as ungrouped data elements formatted as a block of binary via a fixed memory offset using either fixed storage allocation, circular queue techniques, or best practices with respect to memory management (e.g., paged memory, least recently used, etc.). By using BLOB methods, the ability to store various data sets that have different formats facilitates the storage of data associated with the financial transaction instrument by multiple and unrelated owners of the data sets. For example, a first data set which may be stored may be provided by a first party, a second data set which may be stored may be provided by an unrelated second party, and yet a third data set which may be stored, may be provided by an third party unrelated to the first and second party. Each of these three exemplary data sets may contain different information that is stored using different data storage formats and/or techniques. Further, each data set may contain subsets of data that also may be distinct from other subsets.

As stated above, in various embodiments, the data can be stored without regard to a common format. However, in one exemplary embodiment, the data set (e.g., BLOB) may be annotated in a standard manner when provided for manipulating the data onto the financial transaction instrument. The annotation may comprise a short header, trailer, or other appropriate indicator related to each data set that is configured to convey information useful in managing the various data sets. For example, the annotation may be called a “condition header”, “header”, “trailer”, or “status”, herein, and may comprise an indication of the status of the data set or may include an identifier correlated to a specific issuer or owner of the data. In one example, the first three bytes of each data set BLOB may be configured or configurable to indicate the status of that particular data set; e.g., LOADED, INITIALIZED, READY, BLOCKED, REMOVABLE, or DELETED. Subsequent bytes of data may be used to indicate for example, the identity of the issuer, user, transaction/membership account identifier or the like. Each of these condition annotations are further discussed herein.

The data set annotation may also be used for other types of status information as well as various other purposes. For example, the data set annotation may include security information establishing access levels. The access levels may, for example, be configured to permit only certain individuals, levels of employees, companies, or other entities to access data sets, or to permit access to specific data sets based on the transaction, merchant, issuer, user or the like. Furthermore, the security information may restrict/permit only certain actions such as accessing, modifying, and/or deleting data sets. In one example, the data set annotation indicates that only the data set owner or the user are permitted to delete a data set, various identified users may be permitted to access the data set for reading, and others are altogether excluded from accessing the data set. However, other access restriction parameters may also be used allowing various entities to access a data set with various permission levels as appropriate.

The data, including the header or trailer may be received by a stand alone interaction device configured to add, delete, modify, or augment the data in accordance with the header or trailer. As such, in one embodiment, the header or trailer is not stored on the transaction device along with the associated issuer-owned. data but instead the appropriate action may be taken by providing to the transaction instrument user at the stand alone device, the appropriate option for the action to be taken. The system may contemplate a data storage arrangement wherein the header or trailer, or header or trailer history, of the data is stored on the transaction instrument in relation to the appropriate data.

One skilled in the art will also appreciate that, for security reasons, any databases, systems, devices, servers or other components of the system may consist of any combination thereof at a single location or at multiple locations, wherein each database or system includes any of various suitable security features, such as firewalls, access codes, encryption, decryption, compression, decompression, and/or the like.

Encryption may be performed by way of any of the techniques now available in the art or which may become available—e.g., Twofish, RSA, EI Gamal, Schorr signature, DSA, PGP, PKI, GPG (GnuPG), and symmetric and asymmetric cryptosystems.

The computing unit of the web client may be further equipped with an Internet browser connected to the Internet or an intranet using standard dial-up, cable, DSL or any other Internet protocol known in the art. Transactions originating at a web client may pass through a firewall in order to prevent unauthorized access from users of other networks. Further, additional firewalls may be deployed between the varying components of GGS to further enhance security.

Firewall may include any hardware and/or software suitably configured to protect CMS components and/or enterprise computing resources from users of other networks. Further, a firewall may be configured to limit or restrict access to various systems and components behind the firewall for web clients connecting through a web server. Firewall may reside in varying configurations including Stateful Inspection, Proxy based, access control lists, and Packet Filtering among others. Firewall may be integrated within an web server or any other CMS components or may further reside as a separate entity. A firewall may implement network address translation (“NAT”) and/or network address port translation (“NAPT”). A firewall may accommodate various tunneling protocols to facilitate secure communications, such as those used in virtual private networking. A firewall may implement a demilitarized zone (“DMZ”) to facilitate communications with a public network such as the Internet. A firewall may be integrated as software within an Internet server, any other application server components or may reside within another computing device or may take the form of a standalone hardware component.

The computers discussed herein may provide a suitable website or other Internet-based graphical user interface which is accessible by users. In one embodiment, the Microsoft Internet Information Server (IIS), Microsoft Transaction Server (MTS), and Microsoft SQL Server, are used in conjunction with the Microsoft operating system, Microsoft NT web server software, a Microsoft SQL Server database system, and a Microsoft Commerce Server. Additionally, components such as Access or Microsoft SQL Server, Oracle, Sybase, Informix MySQL, Interbase, etc., may be used to provide an Active Data Object (ADO) compliant database management system. In one embodiment, the Apache web server is used in conjunction with a Linux operating system, a MySQL database, and the Perl, PHP, and/or Python programming languages.

Any of the communications, inputs, storage, databases or displays discussed herein may be facilitated through a website having web pages. The term “web page” as it is used herein is not meant to limit the type of documents and applications that might be used to interact with the user. For example, a typical website might include, in addition to standard HTML documents, various forms, Java applets, JavaScript, active server pages (ASP), common gateway interface scripts (CGI), extensible markup language (XML), dynamic HTML, cascading style sheets (CSS), AJAX (Asynchronous Javascript And XML), helper applications, plug-ins, and the like. A server may include a web service that receives a request from a web server, the request including a URL (http://yahoo.com/stockquotes/ge) and an IP address (123.56.789.234). The web server retrieves the appropriate web pages and sends the data or applications for the web pages to the IP address. Web services are applications that are capable of interacting with other applications over a communications means, such as the interact. Web services are typically based on standards or protocols such as XML, SOAP, AJAX, WSDL and UDDI. Web services methods are well known in the art, and are covered in many standard texts. See, e.g., ALEX NGHIEM, IT WEB SERVICES: A ROADMAP FOR THE ENTERPRISE (2003), hereby incorporated by reference.

Middleware may include any hardware and/or software suitably configured to facilitate communications and/or process transactions between disparate computing systems. Middleware components are commercially available and known in the art. Middleware may be implemented through commercially available hardware and/or software, through custom hardware and/or software components, or through a combination thereof. Middleware may reside in a variety of configurations and may exist as a standalone system or may be a software component residing on the Internet server. Middleware may be configured to process transactions between the various components of an application server and any number of internal or external systems for any of the purposes disclosed herein. WebSphere MQTM (formerly MQSeries) by IBM, Inc. (Armonk, N.Y.) is an example of a commercially available middleware product. An Enterprise Service Bus (“ESB”) application is another example of middleware.

Practitioners will also appreciate that there are a number of methods for displaying data within a browser-based document. Data may be represented as standard text or within a fixed list, scrollable list, drop-down list, editable text field, fixed text field, pop-up window, and the like. Likewise, there are a number of methods available for modifying data in a web page such as, for example, free text entry using a keyboard, selection of menu items, check boxes, option boxes, and the like.

The system and method may be described herein in terms of functional block components, screen shots, optional selections and various processing steps. It should be appreciated that such functional blocks may be realized by any number of hardware and/or software components configured to perform the specified functions. For example, the system may employ various integrated circuit components, e.g., memory elements, processing elements, logic elements, look-up tables, and the like, which may carry out a variety of functions under the control of one or more microprocessors or other control devices. Similarly, the software elements of the system may be implemented with any programming or scripting language such as C, C++, C#, Java, JavaScript, VBScript, Macromedia Cold Fusion, COBOL, Microsoft Active Server Pages, assembly, PERL, PHP, awk, Python, Visual Basic, SQL Stored Procedures, PL/SQL, any UNIX shell script, and extensible markup language (XML) with the various algorithms being implemented with any combination of data structures, objects, processes, routines or other programming elements. Further, it should be noted that the system may employ any number of conventional techniques for data transmission, signaling, data processing, network control, and the like. Still further, the system could be used to detect or prevent security issues with a client-side scripting language, such as JavaScript, VBScript or the like. For a basic introduction of cryptography and network security, see any of the following references: (1) “Applied Cryptography: Protocols, Algorithms, And Source Code in C,” by Bruce Schneier, published by John Wiley & Sons (second edition, 1995); (2) “Java Cryptography” by Jonathan Knudson, published by O'Reilly & Associates (1998); (3) “Cryptography & Network Security; Principles & Practice” by William Stallings, published by Prentice Hall; all of which are hereby incorporated by reference.

As will be appreciated by one of ordinary skill in the art, the system may be embodied as a customization of an existing system, an add-on product, a processing apparatus executing upgraded software, a stand alone system, a distributed system, a method, a data processing system, a device for data processing, and/or a computer program product. Accordingly, any portion of the system or a module may take the form of a processing apparatus executing code, interact based embodiment, an entirely hardware embodiment, or an embodiment combining aspects of the interact, software and hardware. Furthermore, the system may take the form of a computer program product on a computer-readable storage medium having computer-readable program code means embodied in the storage medium. Any suitable computer-readable storage medium may be utilized, including hard disks, CD-ROM, optical storage devices, magnetic storage devices, and/or the like.

Phrases and terms similar to an “entity” may include any individual, consumer, customer, group, business, organization, government entity, transaction account issuer or processor (e.g., credit, charge, etc), merchant, consortium of merchants, account holder, charitable organization, software, hardware, and/or any other type of entity. The terms “user,” “consumer,” “purchaser,” and/or the plural form of these terms are used interchangeably throughout herein to refer to those persons or entities that are alleged to be authorized to use a transaction account.

The phrases consumer, customer, user, account holder, account affiliate, cardmember or the like shall include any person, entity, business, government organization, business, software, hardware, machine associated with a transaction account, buys merchant offerings offered by one or more merchants using the account and/or who is legally designated for performing transactions on the account, regardless of whether a physical card is associated with the account, For example, the cardmember may include a transaction account owner, a transaction account user, an account affiliate, a child account user, a subsidiary account user, a beneficiary of an account, a custodian of an account, and/or any other person or entity affiliated or associated with a transaction account.

Phrases and terms similar to “account”, “account number”, “account code” or “consumer account” as used herein, may include any device, code (e.g., one or more of an authorization/access code, personal identification number (“PIN”), Internet code, other identification code, and/or the like), number, letter, symbol, digital certificate, smart chip, digital signal, analog signal, biometric or other identifier/indicia suitably configured to allow the consumer to access, interact with or communicate with the system. The account number may optionally be located on or associated with a rewards account, charge account, credit account, debit account, prepaid account, telephone card, embossed card, smart card, magnetic stripe card, bar code card, transponder, radio frequency card or an associated account.

Phrases and terms similar to “transaction account” may include any account that may be used to facilitate a financial transaction.

A “consumer profile” or “consumer profile data” may comprise any information or data about a consumer that describes an attribute associated with the consumer (e.g., a preference, an interest, demographic information, personally identifying information, and the like).

Any communication, transmission and/or channel discussed herein may include any system or method for delivering content (e.g. data, information, metadata, etc), and/or the content itself. The content may be presented in any form or medium, and in various embodiments, the content may be delivered electronically and/or capable of being presented electronically. For example, a channel may comprise a website or device (e.g., Facebook, YOUTube, AppleTV, Pandora, xBox, Sony Playstation), a uniform resource locator (“URL”), a document (e.g., a Microsoft Word document, a Microsoft Excel document, an Adobe .pdf document, etc.), an “ebook,” an “magazine,” an application or microapplication (as described herein), an SMS or other type of text message, an email, facebook, twitter, MMS and/or other type of communication technology. In various embodiments, a channel may be hosted or provided by a data partner. In various embodiments, the distribution channel and/or the may comprise at least one of a merchant website, a social media website, affiliate or partner websites, an external vendor, a mobile device communication, social media network and/or location based service. Distribution channels may include at least one of a merchant website, a social media site, affiliate or partner websites, an external vendor, and a mobile device communication. Examples of social media sites include Facebook®, foursquare®, Twitter®, MySpace®, LinkedIn®, and the like. Examples of affiliate or partner websites include American Express®, Groupon®, LivingSocial®, and the like. Moreover, examples of mobile device communications include texting, email, and mobile applications for smartphones.

In various embodiments, the methods described herein are implemented using the various particular machines described herein. The methods described herein may be implemented using the described particular machines, and those hereinafter developed, in any suitable combination, as would be appreciated immediately by one skilled in the art. Further, as is unambiguous from this disclosure, the methods described herein may result in various transformations of certain articles.

For the sake of brevity, conventional data networking, application development and other functional aspects of the systems (and components of the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a practical system.

The present system or any part(s) or function(s) thereof may be implemented using hardware, software or a combination thereof and may be implemented in one or more computer systems or other processing systems. However, the manipulations performed by embodiments were often referred to in terms, such as matching or selecting, which are commonly associated with mental operations performed by a human operator. No such capability of a human operator is necessary, or desirable in most cases, in any of the operations described herein. Rather, the operations may be machine operations. Useful machines for performing the various embodiments include general purpose digital computers or similar devices.

In fact, in various embodiments, the embodiments are directed toward one or more computer systems capable of carrying out the functionality described herein. The computer system includes one or more processors, such as processor. The processor is connected to a communication infrastructure (e.g., a communications bus, cross over bar, or network). Various software embodiments are described in terms of this exemplary computer system. After reading this description, it will become apparent to a person skilled in the relevant art(s) how to implement various embodiments using other computer systems and/or architectures. Computer system can include a display interface that forwards graphics, text, and other data from the communication infrastructure (or from a flume buffer not shown) for display on a display unit.

Computer system also includes a main memory, such as for example random access memory (RAM), and may also include a secondary memory. The secondary memory may include, for example, a hard disk drive and/or a removable storage drive, representing a floppy disk drive, a magnetic tape drive, an optical disk drive, etc. The removable storage drive reads from and/or writes to a removable storage unit in a well-known manner. Removable storage unit represents a floppy disk, magnetic tape, optical disk, etc. which is read by and written to by removable storage drive. As will be appreciated, the removable storage unit includes a computer usable storage medium having stored therein computer software and/or data.

In various embodiments, secondary memory may include other similar devices for allowing computer programs or other instructions to be loaded into computer system. Such devices may include, for example, a removable storage unit and an interface. Examples of such may include a program cartridge and cartridge interface (such as that found in video game devices), a removable memory chip (such as an erasable programmable read only memory (EPROM), or programmable read only memory (PROM)) and associated socket, and other removable storage units and interfaces, which allow software and data to be transferred from the removable storage unit to computer system.

Computer system may also include a communications interface. Communications interface allows software and data to be transferred between computer system and external devices, Examples of communications interface may include a modem, a network interface (such as an Ethernet card), a communications port, a Personal Computer Memory Card International Association (PCMCIA) slot and card, etc. Software and data transferred via communications interface are in the form of signals which may be electronic, electromagnetic, optical or other signals capable of being received by communications interface. These signals are provided to communications interface via a communications path (e.g., channel). This channel carries signals and may be implemented using wire, cable, fiber optics, a telephone line, a cellular link, a radio frequency (RF) link, wireless and other communications channels.

The terms “computer program medium” and “computer usable medium” are used to generally refer to media such as removable storage drive and a hard disk installed in hard disk drive. These computer program products provide software to computer system.

Computer programs (also referred to as computer control logic) are stored in main memory and/or secondary memory. Computer programs may also be received via communications interface. Such computer programs, when executed, enable the computer system to perform the features as discussed herein. In particular, the computer programs, when executed, enable the processor to perform the features of various embodiments. Accordingly, such computer programs represent controllers of the computer system.

In various embodiments, software may be stored in a computer program product and loaded into computer system using removable storage drive, hard disk drive or communications interface. The control logic (software), when executed by the processor, causes the processor to perform the functions of various embodiments as described herein. In various embodiments, hardware components such as application specific integrated circuits (ASICs). Implementation of the hardware state machine so as to perform the functions described herein will be apparent to persons skilled in the relevant art(s).

In various embodiments, the server may include application servers (e.g. WEB SPHERE, WEB LOGIC, BOSS). In various embodiments, the server may include web servers (e.g. APACHE, IIS, GWS, SUN JAVA SYSTEM WEB SERVER).

The system may include or interface with any of the foregoing accounts, devices, and/or a transponder and reader (e.g. REID reader) in RE communication with the transponder (which may include a fob), or communications between an initiator and a target enabled by near field communications (NFC). Typical devices may include, for example, a key ring, tag, card, cell phone, wristwatch or any such form capable of being presented for interrogation. Moreover, the system, computing unit or device discussed herein may include a “pervasive computing device,” which may include a traditionally non-computerized device that is embedded with a computing unit. Examples may include watches, Internet enabled kitchen appliances, restaurant tables embedded with RF readers, wallets or purses with imbedded transponders, etc. Furthermore, a device or financial transaction instrument may have electronic and communications functionality enabled, for example, by: a network of electronic circuitry that is printed or otherwise incorporated onto or within the transaction instrument (and typically referred to as a “smart card”); a fob having a transponder and an RFD reader; and/or near field communication (NFC) technologies. For more information regarding NFC, refer to the following specifications all of which are incorporated by reference herein: ISO/IEC 18092/ECMA-340, Near Field Communication Interface and Protocol-1 (NFCIP-1); ISO/IEC 21481/ECMA-352, Near Field Communication Interface and Protocol-2 (NFCIP-2); and EMV 4.2.

Phrases and terms similar to “business” or “merchant” may be used interchangeably with each other and shall mean any person, entity, distributor system, software and/or hardware that is a provider, broker and/or any other entity in the distribution chain of goods or services. For example, a merchant may be a grocery store, a retail store, a travel agency, a service provider, an on-line merchant or the like.

These computer program instructions may be loaded onto a general purpose computer, special purpose computer, or other programmable data processing apparatus to produce a machine, such that the instructions that execute on the computer or other programmable data processing apparatus create means for implementing the functions specified in the flowchart block or blocks. These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

In yet another embodiment, the transponder, transponder-reader, and/or transponder-reader system are configured with a biometric security system that may be used for providing biometrics as a secondary form of identification. The biometric security system may include a transponder and a reader communicating with the system. The biometric security system also may include a biometric sensor that detects biometric samples and a device for verifying biometric samples. The biometric security system may be configured with one or more biometric scanners, processors and/or systems. A biometric system may include one or more technologies, or any portion thereof, such as, for example, recognition of a biometric. As used herein, a biometric may include a user's voice, fingerprint, facial, ear, signature, vascular patterns, DNA sampling, hand geometry, sound, olfactory, keystroke/typing, iris, retinal or any other biometric relating to recognition based upon any body part, function, system, attribute and/or other characteristic, or any portion thereof.

Accordingly, functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions. Further, illustrations of the process flows and the descriptions thereof may make reference to user windows, webpages, websites, web forms, prompts, etc. Practitioners will appreciate that the illustrated steps described herein may comprise in any number of configurations including the use of windows, webpages, web forms, popup windows, prompts and the like. It should be further appreciated that the multiple steps as illustrated and described may be combined into single webpages and/or windows but have been expanded for the sake of simplicity. In other cases, steps illustrated and described as single process steps may be separated into multiple webpages and/or windows but have been combined for simplicity.

The term “non-transitory” is to be understood to remove only propagating transitory signals per se from the claim scope and does not relinquish rights to all standard computer readable media that are not only propagating transitory signals per se. Stated another way, the meaning of the term “non-transitory computer-readable medium” and “non-transitory computer-readable storage medium” should be construed to exclude only those types of transitory computer-readable media which were found in In Re Nuijten to fall outside the scope of patentable subject matter under 35 §101.

Benefits, other advantages, and solutions to problems have been described herein with regard to specific embodiments. However, the benefits, advantages, solutions to problems, and any elements that may cause any benefit, advantage, or solution to occur or become more pronounced are not to be construed as critical, required, or essential features or elements of the disclosure. The scope of the disclosure is accordingly to be limited by nothing other than the appended claims, in which reference to an element in the singular is not intended to mean “one and only one” unless explicitly so stated, but rather “one or more,” Moreover, where a phrase similar to ‘at least one of A, B, and C’ or ‘at least one of A, B, or C’ is used in the claims or specification, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C. Although the disclosure includes a method, it is contemplated that it may be embodied as computer program instructions on a tangible computer-readable carrier, such as a magnetic or optical memory or a magnetic or optical disk.

All structural, chemical, and functional equivalents to the elements of the above-described exemplary embodiments that are known to those of ordinary skill in the art are expressly incorporated herein by reference and are intended to be encompassed by the present claims. Moreover, it is not necessary for a device or method to address each and every problem sought to be solved by the present disclosure, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.” As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

1. A computer-implemented method comprising:
identifying, by a computer-based system capable of facilitating gift giving, a contact of a consumer;
acquiring, by the computer-based system, personal information for the contact;
determining, by the computer-based system and based on consumer preferences, that the contact should receive a gift; and
sending, by the computer-based system, a gift to the contact on behalf of the consumer,

2. The method of claim 1, further comprising identifying, by the computer-based system, interests of the contact based on information in a social media profile of the contact.

3. The method of claim 1, further comprising identifying, by the computer-based system, popular gift items based on at least one of the contact's personal information or a price range.

4. The method of claim 1, further comprising providing, by the computer-based system, the consumer with a list of suggested gift items for the contact.

5. The method of claim 1, further comprising identifying, by the computer-based system, a trigger, wherein the trigger indicates that a gift should be sent to the contact.

6. The method of claim 5, wherein the trigger comprises an update to a social media profile.

7. The method of claim 1, wherein the acquiring personal information comprises accessing a social media profile of the contact via an application program interface.

8. The method of claim 1, further comprising selecting, by the computer-based system, the gift on behalf of the consumer.

9. The method of claim 8, further comprising storing, by the computer-based system, transaction account information of the consumer and automatically purchasing the gift on behalf of the consumer.

10. The method of claim 1, further comprising accessing, by the computer-based system, a gift registry for the contact.

11. The method of claim 1, wherein the identifying a contact of the consumer comprises accessing, by the computer-based system, a social media account of the consumer and identifying a social media contact of the consumer.

12. The method of claim 4, further comprising adjusting, by the computer-based system, a ranking of the suggested gift items based on a third-party sponsorship.

13. The method of claim 1, further comprising enrolling, by the computer-based system, the consumer in an auto-ship program.

14. The method of claim 1, further comprising transmitting, by the computer-based system, a request for an address to the contact.

15. The method of claim 1, further comprising notifying, by the computer-based system, the consumer of a gift that would have been selected for a previous occasion had the consumer been enrolled in auto-ship.

16. The method of claim 1, further comprising transmitting, by the computer-based system, a reminder for a gift occasion to the consumer.

17. The method of claim 4, further comprising removing, by the computer-based system, items from the list which have been previously purchased for the contact.

18. The method of claim 1, further comprising transmitting, by the computer-based system, a message to the contact, wherein the message appears to originate from the consumer.

19. An article of manufacture including a non-transitory, tangible computer readable storage medium having instructions stored thereon that, in response to execution by a computer-based system capable of facilitating gift giving, cause the computer-based system to be capable of performing operations comprising:
identifying, by the computer-based system, a contact of a consumer;
acquiring, by the computer-based system, personal information for the contact;
determining, by the computer-based system and based on consumer preferences, that the contact should receive a gift; and
sending, by the computer-based system, a gift to the contact on behalf of the consumer. 20, A system comprising:
a processor capable of facilitating gift giving,
a tangible, non-transitory memory configured to communicate with the processor,
the tangible, non-transitory memory having instructions stored thereon that, in response to execution by the processor, cause the processor to be capable of performing operations comprising:
identifying, by the processor, a contact of a consumer;
acquiring, by the processor, personal information for the contact;
determining, by the computer-based system and based on consumer preferences, that the contact should receive a gift; and
sending, by the processor, a gift to the contact on behalf of the consumer.
